(19) United States
(12) Patent Application Publication
(10) Pub. No.: US 2009/0265185 A1
(43) Pub. Date: Oct. 22, 2009

(54) CARE COORDINATION INFORMATION SYSTEM

(75) Inventors: CHRISTOPHER FINN, Liberty, MO (US); DAVID McCALLIE, Stilwell, KS (US); STEVEN S. CROOKS, Gladstone, MO (US); DAVID O'LARTE, Peculiar, MO (US)

Correspondence Address: SHOOK, HARDY & BACON L.L.P.;Intellectual Property Department, 2555 GRAND BOULEVARD, KANSAS CITY, MO, 64108-2613, US

(73) Assignee: CERNER INNOVATION, INC., Overland Park, KS (US)

(21) Appl. No.: 12/039,240

(22) Filed: Feb. 28, 2008

Related U.S. Application Data
(60) Provisional application No. 60/892,003, filed on Feb. 28, 2007.

(51) Int. Cl. G06Q 50/00; G06F 3/048

(52) U.S. Cl. 705/3; 705/4; 715/810

(57) ABSTRACT

Systems and associated methods are disclosed for coordinating health services delivery within a patient population. In certain embodiments, a system and associated methods facilitate the presentation of patient-specific information on a shared site accessible by a group of users. Edits may also be made to the patient-specific information by specific users, so that the group of users can observe the changes and provide additional input. In other embodiments, a system and associated methods are utilized to determine a priority scheme with regard to delivering care to a plurality of patients. The priority scheme is represented by a graphical ranking where patients having a similar ranking are presented proximal to one another and patients having a dissimilar ranking are presented distal to one another.

### CROSS-REFERENCE TO RELATED APPLICATIONS

This application claims priority to commonly owned U.S. provisional application Ser. No. 60/892,003, filed Feb. 28, 2007, incorporated by reference herein.

### STATEMENT REGARDING FEDERALLY SPONSORED RESEARCH OR DEVELOPMENT

Not applicable.

### BACKGROUND

The health needs of persons requiring long term health monitoring and care delivery can be difficult to manage. In addition to requiring involvement by traditional health service providers such as physicians and nurses, other individuals are often needed to coordinate daily activities and the delivery of health services. As one example, case managers may be utilized by an insurance company to monitor health service delivery to patients with type II diabetes to ensure that insulin delivery and corresponding health assessments are provided to the patients in a most cost effective and efficient way. The case manager may advocate directly on behalf of the patient with entities involved in the delivery of health services, or may function in a more passive role where the patient is merely “checked on” from time to time and encouraged to seek appropriate care when needed. Depending on the particular health conditions of relevant patients, as well as other considerations such as available economic resources, health service coordinators (e.g., case managers) may have as few as one to as many as dozens of patients to monitor.

While coordinators provide some oversight in health service delivery, difficulties still arise with regard to prioritizing care management in the case of a large patient population. At any given moment, multiple patients may have immediate needs that cannot be simultaneously addressed by a designated health service coordinator. Accordingly, a coordinator will typically attempt to focus on a patient appearing have the “most serious” health ailment at the present point in time. This situation requires a difficult subjective evaluation by the coordinator, and also may encourage health service providers to unduly advocate for the seriousness of their patient's condition to secure more immediate attention from the coordinator. So current prioritization schemes for health service coordination often result in inconsistent management of chronic health conditions across the group of patients.

Compounding the difficulty of managing chronic diseases and other conditions for a given patient is the fact that other activities or circumstances surrounding health service delivery may not be within the purview or knowledge of the case manager. Family members, for instance, may provide some care delivery or coordinate on their own with certain vendors or service providers (e.g., durable medical equipment (DME) suppliers) without involving a health service provider or case manager. Moreover, the expense of having case managers and other coordinators involved in health service management cannot be justified in all patient care situations.

Another problem that arises in managing long term care delivery is a lack of coordination between health service providers for a given patient. Frequently, one provider, or “clinician”, is unaware of the care being delivered to, or observations made of, a patient by another clinician. This is especially true if there is an overlapping timeframe in which the clinicians are both treating the patient. Even with the advent of electronic medical or health records (EMR), care coordination for a patient can be difficult due to the limited scope and types of information that are embodied in the EMR. Some degree of care delivery management may be accomplished with a progress note, or a log of patient assessments or other care administered by clinicians to a patient. This progress note allows designated individuals to review information pertinent to the progress of care delivery for the specific patient. While such a chronology of patient care information is somewhat useful, it becomes difficult to manage once the progress note becomes sufficiently large, at which point a clinician has to sift through so much information that a particular piece of relevant information is hard to find. As can be imagined, the use of traditional progress notes can slow the process of evaluating a patient's current health status and delivering appropriate care to the point where clinicians avoid their use altogether.

### BRIEF SUMMARY

Systems and associated methods of the present invention provide a robust solution for coordinating the delivery of health services for a given patient population. In particular, embodiments provide current patient-specific information on a shared site accessible by a number of care providers and coordinators, who may then review the information and provide additional content.

In one aspect, a computing system is provided for managing, among a number of authorized users, patient-specific information for presentation in a categorized form. The system includes a content management module for managing the organization of content on a shared network site, a display module for presenting to a particular user the content as patient-specific categorized information, and an editing module for selectively enabling modification by the authorized users of the patient-specific categorized information. The display module is also configured to present the content for display in a format consistent with preferences designated by the particular user. Upon modification of the patient-specific categorized information, the display module may subsequently display the modified information for any of the authorized users accessing the system. In this way, multiple users contribute to the content regarding a particular patient to enable any of the authorized users, such as a health service providers or coordinators, to provide the most appropriate care based on the shared content input.

In another aspect, a computerized method is provided for managing the presentation of categorized patient-specific information among a number of users. According to the method, a patient-specific information set is retrieved for a particular user from a shared network site. The retrieved information set is then selectively displayed for the particular user in a categorized format consistent with preferences designated by the particular user. At this point, the user may make modifications to content of the retrieved information set displayed, which are utilized to compile a modified patient-specific information set. This modified information set is stored on the shared network site to facilitate access thereto by the particular user that has made the modifications or by other users as desired. Through continual access and modification by the users, the information for the specific patient evolves to provide an updated data compilation useful in managing care delivery to such patient. Additionally, by displaying the information in a categorized format, and in accordance with the preferences, a particular user can focus on specific information that is most relevant to their role in delivering health services to or managing the care of the patient in question.

In yet another aspect, a computerized system and method is utilized in providing formatted updates regarding a patient based on the modification of content present on a shared network site. According to the method, a subscription request is received, which is associated with a particular care provider and a particular patient. Content modification that occurs on the shared network site that is relevant to the subscription request is then registered. Based on the content modification registered, formatted updates for the particular care provider regarding the particular patient are selectively generated, where the updates relate to the content modification registered. This enables care providers to be timely informed of relevant updates that have occurred to information regarding a particular patient, without having to necessarily review previous versions of the patient information.

Certain embodiments of the system and associated methods of the present invention provide a user interface for managing the presentation of patient-specific information that is accessible by a number of users. The user interface includes one or more display regions configured for presenting the patient-specific information in categorized form based on preferences designated by a particular user of the number of users. Additionally, the user interface presents patient-specific information that is inclusive of content modifications previously instituted by various users.

In another aspect, a computerized method is provided for determining a priority scheme with regard to delivering care to a number of patients. More specifically, the method first involves retrieving one or more sets of patient-specific data for the number of patients related to care delivery. As one example, the patient-specific data may include health information or other types of information. Based on the patient-specific data retrieved, the need to receive care for each of the number of patients is ranked. The results of the ranking are then displayed in accordance with a visualization scheme on a user interface where patients having a similar ranking are presented proximal to one another and patients having a dissimilar ranking are presented distal to one another. Additionally, certain embodiments of the system and associated methods of the present invention provide various user interfaces for instituting the visualization scheme for designating a suggested priority among the patients for receiving care. One user interface includes one or more display regions configured for presenting an ordered chart including a listing of the number of patients in ranked order. The ordered chart has a set of regions, with each region denoting a unique range of ranking values for the number of patients and being provided with a distinctive visual indicator to distinguish one region from another region. Another user interface includes one or more display regions configured for presenting a graphical plot of ranking values for the number of patients. The graphical plot has a set of regions, with each region denoting a unique range of ranking values for the number of patients and being provided with a distinctive visual indicator to distinguish one region from another region.

Additional advantages and features of the invention will be set forth in part in a description which follows, and in part will become apparent to those skilled in the art upon examination of the following, or may be learned by practice of the invention.

### BRIEF DESCRIPTION OF THE SEVERAL VIEWS OF THE DRAWING

The present invention is described in detail below with reference to the attached drawing figures, wherein:

FIG. 1 is a block diagram of an exemplary computing system environment suitable for use in implementing the present invention;

FIG. 2 is a block diagram of one embodiment of a set of component modules illustrating the flow of information into the component modules and related activity for coordinating health service delivery;

FIG. 3 is an illustrative screen display showing a patient search region and a search results;

FIG. 4 is an illustrative screen display showing an “At A Glance” tab selected from an Overview window populated with care delivery information and tasks for a particular patient;

FIG. 5 is an illustrative screen display showing a “Facesheet” tab selected from the Overview window populated with general medical conditions care delivery information and tasks for a particular patient;

FIG. 6 is an illustrative screen display providing a generalized view of the Care Coordination window;

FIG. 7 is an illustrative screen display showing the Care Coordination window with a subscription icon selected;

FIG. 8 is an illustrative screen display showing the Care Coordination window with an option icon selected;

FIG. 9 is an illustrative screen display showing the Care Coordination window with a textbox opened for editing of the information entry;

FIG. 10 is an illustrative screen display showing the Care Coordination window with an information set expanded to show the different versions of the primary information entry;

FIG. 11 is an illustrative screen display showing the Care Coordination window with an information set expanded to show discussion entries;

FIG. 12 is an illustrative screen display showing the Care Coordination window with an information set expanded to show a file attachment;

FIG. 13 is an illustrative screen display showing the Care Coordination window with an “Add File” option selected;

FIG. 14 is an illustrative screen display showing the Care Coordination window with a “Manage Headings” tab selected for establishing default headings;

FIG. 15 is an illustrative screen display providing a generalized view of the Inbox window;

FIG. 16 is an illustrative screen display showing the Tasks window populated with patient-specific tasks;

FIG. 17 is an illustrative screen display showing the Tasks window populated with provider-specific tasks;

FIG. 18 is an illustrative screen display showing the Tasks window populated with a timeline of tasks;

FIG. 19 is an illustrative screen display showing an ordered patient chart establishing a priority to receive care;

FIG. 20 depicts a flow diagram representative of one method for generating a visualization representative of a priority for individual patients to receive care; and

FIG. 21 is an illustrative screen display showing a graphical plot representative of the importance and the urgency of health conditions for particular patients.

### DETAILED DESCRIPTION

Embodiments of the present invention relate to the coordination and management of health service delivery for a given patient population. Specifically, certain embodiments are concerned with a computerized system and associated methods for providing current patient-specific information on a shared site accessible by a plurality of designated users, such as health service providers and coordinators, who may then review the information and provide additional content. The patient-specific information may be presented to the users in a categorical fashion, and more specifically, in accordance with a presentation format selected by each user. In this way, when a health service provider or coordinator is focusing on delivering care or coordinating health service activities for a particular patient, relevant information about the patient is presented in a format most useful to provider/coordinator. Certain embodiments are directed to establishing formatted updates for specific users based on modifications to patient-specific content present on the shared site. This enables users to focus their attention on new developments for the patient that may have more relevance to care delivery and coordination than older information that was previously reviewed or is otherwise no longer relevant to the user. The formatted updates are subscribed to by individual users, and then selectively generated according to user preferences.

Still further, certain embodiments are concerned with a computerized system and associated methods for determining a priority scheme with regard to delivering care to individual patients within a pool of patients. Certain factors are used to evaluate patient-specific data to generate a ranking of the need to receive care for each of the patients. The ranking results are displayed in accordance with a visualization scheme on a user interface where patients having a similar ranking are presented proximal to one another and patients having a dissimilar ranking are presented distal to one another. This allows a user to quickly determine which patients have needs that must be addressed first.

### General Computing System Environment

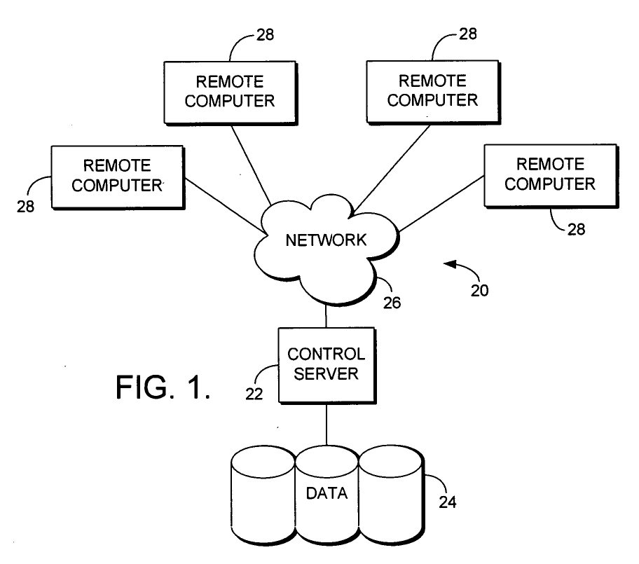

Referring to the drawings in general, and initially to FIG. 1 in particular, an example of a suitable computing system environment in which the invention may be implemented, for instance, a medical information computing system, is illustrated and designated generally as reference numeral 20. It will be understood and appreciated by those of ordinary skill in the art that the illustrated medical information computing system environment 20 is merely an example of one suitable computing environment and is not intended to suggest any limitation as to the scope of use or functionality of the invention. Neither should the medical information computing system environment 20 be interpreted as having any dependency or requirement relating to any single component or combination of components illustrated therein.

The present invention may be operational with numerous other general purpose or special purpose computing system environments or configurations. Examples of well-known computing systems, environments, and/or configurations that may be suitable for use with the present invention include, by way of example only, personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention may be described in the general context of computer-executable instructions, such as program modules, being executed by a computer. Generally, program modules include, but are not limited to, routines, programs, objects, components, and data structures that perform particular tasks or implement particular abstract data types. The present invention may also be practiced in distributed computing environments where tasks are performed by remote processing devices that are linked through a communications network. In a distributed computing environment, program modules may be located in local and/or remote computer storage media including, by way of example only, memory storage devices.

With continued reference to FIG. 1, the exemplary medical information computing system environment 20 includes a general purpose computing device in the form of a control server 22. Components of the control server 22 may include, without limitation, a processing unit, internal system memory, and a suitable system bus for coupling various system components, including database cluster 24, with the control server 22. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The control server 22 typically includes therein, or has access to, a variety of computer readable media, for instance, database cluster 24. Computer readable media can be any available media that may be accessed by control server 22, and includes volatile and nonvolatile media, as well as removable and nonremovable media. By way of example, and not limitation, computer readable media may include computer storage media and communication media. Computer storage media may include, without limitation, volatile and nonvolatile media, as well as removable and nonremovable media implemented in any method or technology for storage of information, such as computer readable instructions, data structures, program modules, or other data. In this regard, computer storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage device, or any other medium which can be used to store the desired information and which may be accessed by control server 22. Communication media typically embodies computer readable instructions, data structures, program modules, or other data in a modulated data signal, such as a carrier wave or other transport mechanism, and may include any information delivery media. As used herein, the term “modulated data signal” refers to a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer readable media

The computer storage media discussed above and illustrated in FIG. 1, including database cluster 24, provide storage of computer readable instructions, data structures, program modules, and other data for control server 22.

The control server 22 may operate in a computer network 26 using logical connections to one or more remote computers 28. Remote computers 28 may be located at a variety of locations in a medical environment or research environment, for example, but not limited to, clinical laboratories, hospitals and other inpatient settings, veterinary environments, ambulatory settings, medical billing and financial offices, administration settings, home health care environments, clinicians' offices, or other healthcare provider or administrative settings. However, remote computers 28 are not limited to these environments, and may be present in other environments where health service delivery, management, or support is provided, including practically any non-traditional medical care environment where patient-related information is accessed and monitored. As mentioned above, remote computers 28 may also be physically located in non-traditional medical care environments so that the entire health care community may be capable of integration on the network. Remote computers 28 may be personal computers, servers, routers, network PCs, personal digital assistants (PDA), peer devices, other common network nodes, or the like, and may include some or all of the elements described above in relation to the control server 22.

Exemplary computer networks 26 may include, without limitation, local area networks (LANs) and/or wide area networks (WANs). Such networking environments are commonplace in offices, enterprise-wide computer networks, intranets, and the Internet. When utilized in a WAN networking environment, the control server 22 may include a modem or other means for establishing communications over the WAN, such as the Internet. In a networked environment, program modules or portions thereof may be stored in the control server 22, in the database cluster 24, or on any of the remote computers 28. For example, and not by way of limitation, various application programs may reside on the memory associated with any one or all of the remote computers 28. It will be appreciated by those of ordinary skill in the art that the network connections shown are exemplary and other means of establishing a communications link between the computers (e.g., control server 22 and remote computers 28) may be utilized.

In operation, a user may enter commands and information into the control server 22 or convey the commands and information to the control server 22 via one or more of the remote computers 28 through input devices, such as a keyboard, a pointing device (commonly referred to as a mouse), a trackball, or a touch pad. Other input devices may include, without limitation, microphones, satellite dishes, scanners, or the like. The control server 22 and/or remote computers 28 may include other peripheral output devices, such as speakers and a printer.

Although many other internal components of the control server 22 and the remote computers 28 are not shown, those of ordinary skill in the art will appreciate that such components and their interconnection are well known. Accordingly, additional details concerning the internal construction of the control server 22 and the remote computers 28 are not further disclosed herein.

### Care Coordination

As referenced above, embodiments of the present invention relate to the coordination and management of health service delivery for a given patient population. In embodiments, a system and associated methods provide current patient-specific information on a shared site accessible by a number of care providers and coordinators, who may then review the information and provide additional content as desired. Additionally, other embodiments are involved with methods for determining a priority scheme with regard to delivering care to individual patients within a pool of patients.

Turning to a general discussion of terminology used throughout the application, health service providers, coordinators, managers and suppliers, and others similarly involved in handling care for a person in need may also be referred to herein as “clinicians”, whether such persons conduct activities within or outside of a traditional medical care environment. The terms “clinician” and “user” are used interchangeably herein to describe individuals that utilize the systems and methods of the present invention on behalf of one or more patients. Electronic health records, as referenced above, are typically associated with each patient encountering a healthcare provider or system. These health records contain various types of data about an individual patient, such as: patient identifying and demographic information; insurance and financial information; patient health status, such as observed conditions of the patient (e.g., physiological conditions such as blood pressure, oxygen saturation levels in blood, or other “vital signs”), current immunizations, food and drug allergies, diagnoses and current assessments of various clinicians; and care documentation including a listing of clinicians that are currently providing or that have provided care to the patient, clinical orders made (e.g., medications prescribed, tests or procedures ordered, and any entities or providers associated therewith) and any corresponding insurance or other payer claims for coverage of the ordered items. It should be understood that the patient data described herein is not an exhaustive list, and any portion of the described patient data (or any patient data not explicitly set out herein) may reside within a health record. Any or all of the information in the electronic health record may be organized into one or more structured charts within the record, and as one example, the EMR may take the form of personal health record (PHR), a continuity of care record (CCR), a structured information set or record residing with a group of patient-specific records in a community health record (CHR), or the like, and is preferably readable across various computing platforms. It should be understood, however, that the term “medical record”, “health record” or “electronic health record” in particular, should not be interpreted to be limited to any type of computer-readable format or record, but includes any electronically-stored data structure containing information relative to at least one specific patient and from which information may be viewed and/or extracted by various components of the computing system environment 20, such as remote computers 28. Additionally, it should be noted that the terms “patient”, “person” and “individual” are used interchangeably herein and are not meant to limit the nature of the referenced individual nor imply any particular relationship between the individual in question and clinicians or other persons having access privileges to patient-centric health record information or other information pertinent to delivering, managing, or coordinating care for the individual (collectively referred to herein as “patient-centric content”).

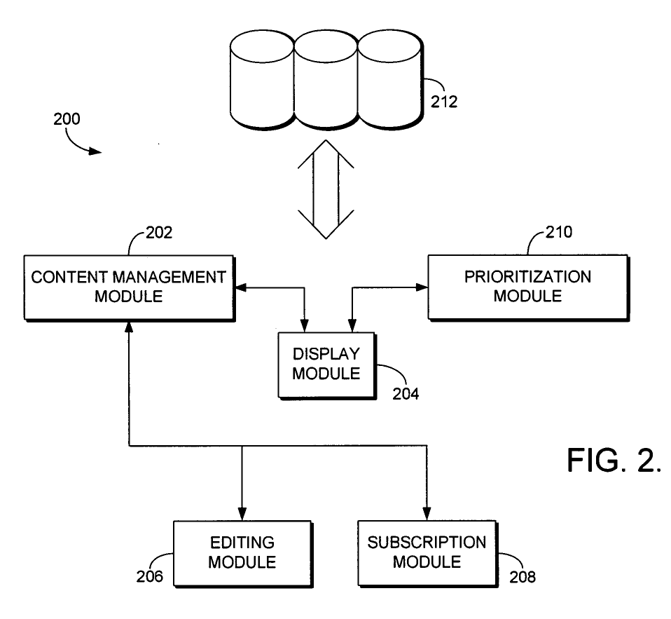

Illustrated in FIG. 2 is the typical flow of activity through a set of general component modules 200 (functioning, for example, within system 20) that enable the sharing and modifying of current patient-centric content (i.e., information specific to each patient) among a group of authorized users consistent with preferences designated by individual users. The modules 200 include a content management module 202 handling the organization of patient-centric content residing on a shared network site, a display module 204 for selectively displaying the shared content among users, as well as displaying ranking results for prioritizing patients to receive care, and an editing module 206 for selectively enabling modification of the patient-centric content. Additionally, the modules 200 include a subscription module 208 handling subscription requests from authorized users for generating formatted updates to users regarding modifications to the patient-centric content, as well as a prioritization module 210 retrieving certain patient-centric content and utilizing such content to rank the need to receive care for the patients. Both the management module 202 and the prioritization module 210 may interface with various data repositories 212 where the patient-centric content is stored, such as a database taking the form of a health information system database.

As explained more fully below, the component modules 200 handle the presentation of information to users (i.e., clinicians) through a series of exemplary screen displays. In an embodiment, the content management module 202 selectively receives commands from the editing module 206 and the subscription module 208 based on clinician input to the system 20 and in correlation with information presented through the exemplary screen displays on display module 204. For instance, if a clinician provides additional patient-specific health information through input associated with a particular screen display, the editing module 206 generates an instruction for the content management module 202 add the particular patient information to the patient record on data repositories 212. This allows other clinicians to then view the updated patient-specific information or content through the display module 204. In another embodiment, the prioritization module 210 generates a visualization for display on the display module 204 representative of the suggested priority for individual patients within a patient population to received care. The suggested patient priority to receive care, or “ranking”, is based at least in part on patient-specific information retrieved from the data repositories 212 by the prioritization module 210.

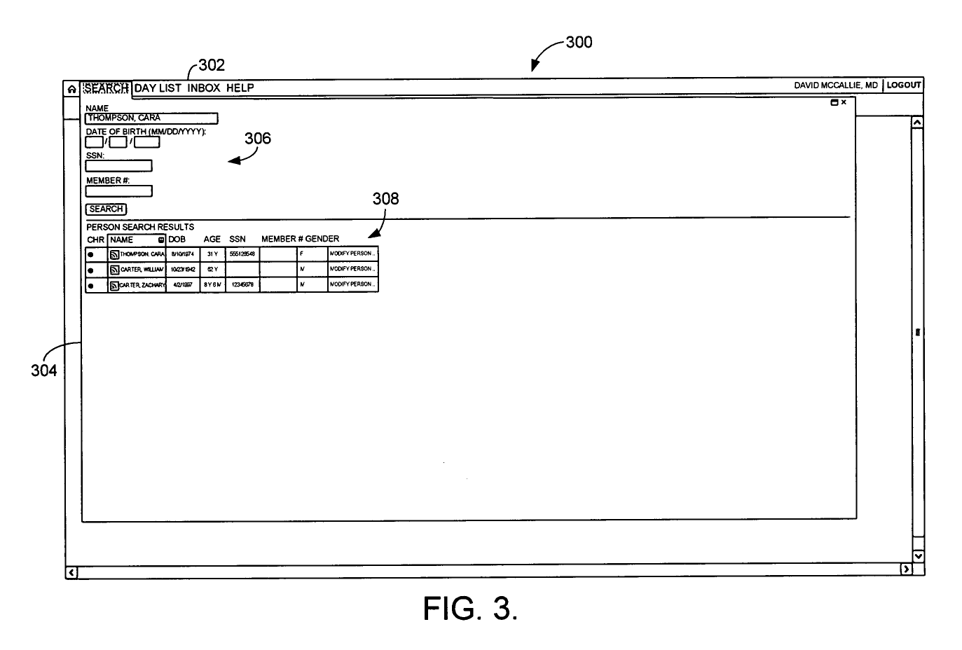

One exemplary screen display 300 generated by the component modules 200 for providing information to a clinician is illustrated in FIG. 3. Screen display 300 presents a menu 302 containing selectable options each providing a separate window 304 upon being selected. From the menu 302, selection of the SEARCH option from the menu generates the window 304 with a patient search region 306 where patient-specific information may be entered for querying the database 24 (e.g., a health information system database) to identify particular patients, and a search results table 308 listing the results from the query. Each matching patient is listed in the search results table 308 along with general identifying information. Information pertinent to care coordination for an identified patient is accessed by selecting the patient's name in the search results table 308. The query results also provide a selectable “Modify Person” option for each patient listed to enable certain identifying information for a patient to be modified.

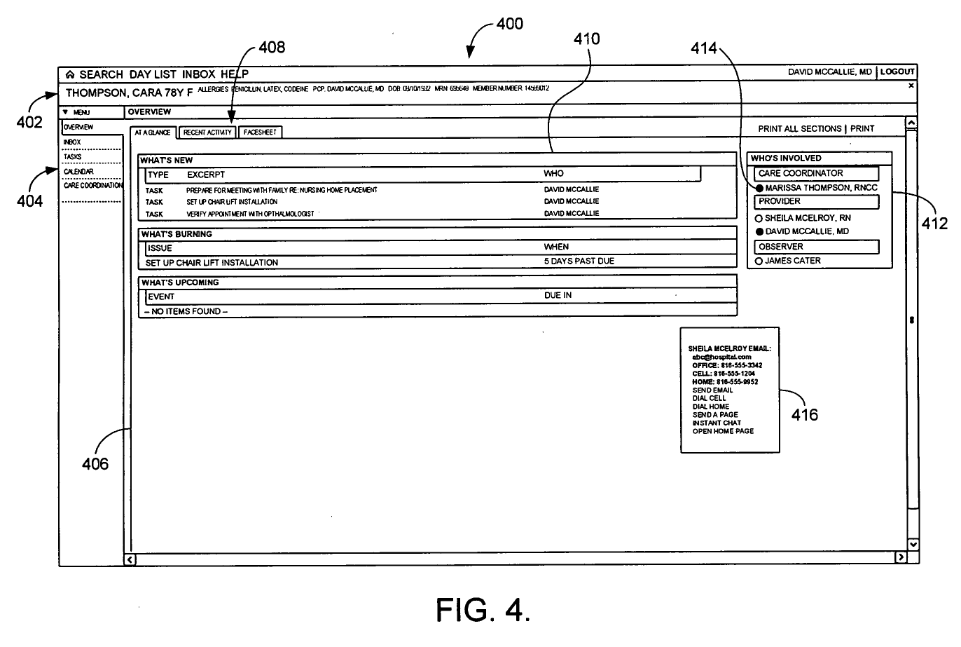

Upon selecting a particular patient from the search results table 308, a screen display 400 is generated as illustrated in FIG. 4. Screen display 400 provides a patient identifying region 402 that contains the particular patient's name and other identifying information, along with selected general health information for the patient. Additionally, a top-level menu 404 of navigation options is provided in screen display 400, for accessing patient information related to care delivery and other information pertinent to coordinating care delivery with other clinicians. In the particular exemplary screen display 400 shown in the FIG. 4, the OVERVIEW option is selected from the menu 404. Window 406 is generated as a result of the menu selection, and provides tabs 408 for selectively presenting an organized set of information surrounding currently relevant information and tasks or other activities surrounding the delivery of care for the particular patient. For instance, the selection of the AT A GLANCE tab 408 causes the window 406 to present a first region 410 populated with listings of newly created tasks or other activities to be conducted in delivering care for the patient, along with the clinician that created the task, as well as listings related to care delivery that are past due and those that are upcoming. Additionally, selection of the AT A GLANCE tab 408 causes the window 406 to present a second region 412 populated with a list of clinicians of record in handling care-related issues for the patient. For instance, these clinicians may be listed in the health record of the particular patient, or in another health system information source. Each clinician has an associated presence icon 414 indicating whether the clinician is presently available to communicate on the system 20. Clinician “presence” is more specifically designated by the present ability of a communication device associated with the clinician to communicate across the system 20, whether the particular device is assigned to the particular clinician or a shared device that is presently being utilized by the clinician (e.g., remote computer 28). In an embodiment, the control server 22 may periodically poll devices assigned to clinicians of record in the system 20 or otherwise check the current log of clinicians that have logged into the system 20. Alternatively, the clinician device may be programmed to generate and transmit a notification alert to the control server 22 when the device is in communication with the system 20. From the clinician list, selection of a particular clinician in the second region 412 causes the generation of sub-window 416. This sub-window 416 provides contact information for the specific clinician as well as designated links to execute various types of communication actions with the list clinician by the current user, such as sending an electronic mail message to the clinician's inbox, dialing the clinician's telephone number (e.g., if the computer 28 has a speaker, microphone, and an application for voice communications), sending the clinician a page, engaging in a text communication session with the clinician (e.g., utilizing, for instance, XMPP/Jabber, Microsoft RTC, or other messaging services), or other activity.

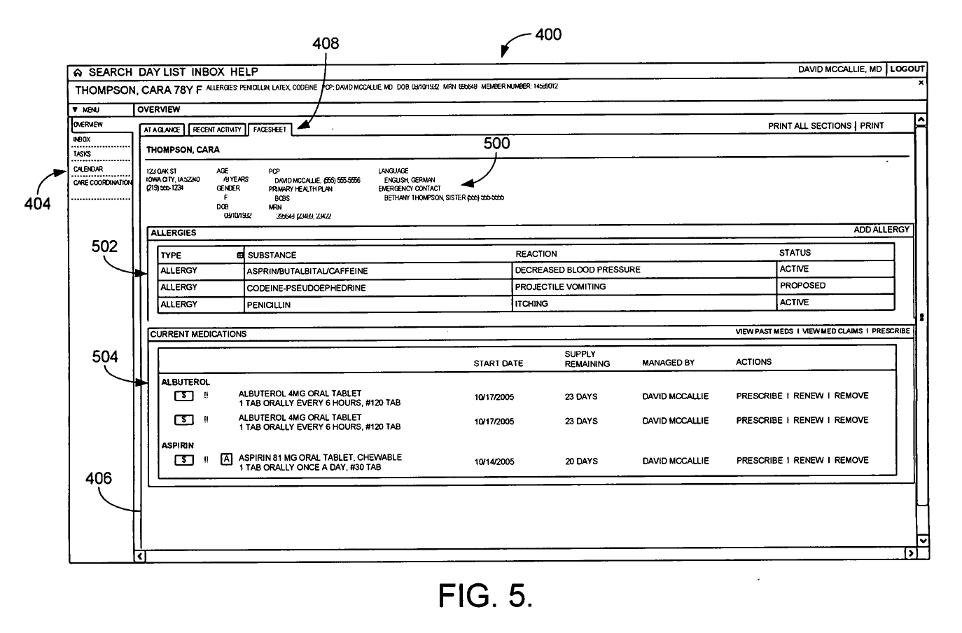

Turning to FIG. 5, screen display 400 is depicted with the FACESHEET tab 408 selected. This selection causes window 406 to present an overview of medical conditions and other care related information for the patient. The information populated into window 406 in FIG. 5 may be extracted from the patient's health record and other sources of patient-centric content, all of which may reside on the health information system database 24. Exemplary types of health information displayed include general identification information 500 for the patient, known food and drug allergy info 502 for the patient, and information 504 regarding medications that are currently being prescribed or have been prescribed to the patient in the past. Selectable actions are also displayed in association with particular medications to enable the clinician to generate a message embodying an instruction to prescribe a medication, renew a current medication prescription, or remove the medication information from display or from an associated list of prescribed medications, as well as to transmit such the message to the appropriate prescription filling entity, such as a pharmacy. If, on the other hand, the RECENT ACTIVITY tab 408 is selected, window 406 presents a list of recent care delivery activities that have been performed for the particular patient.

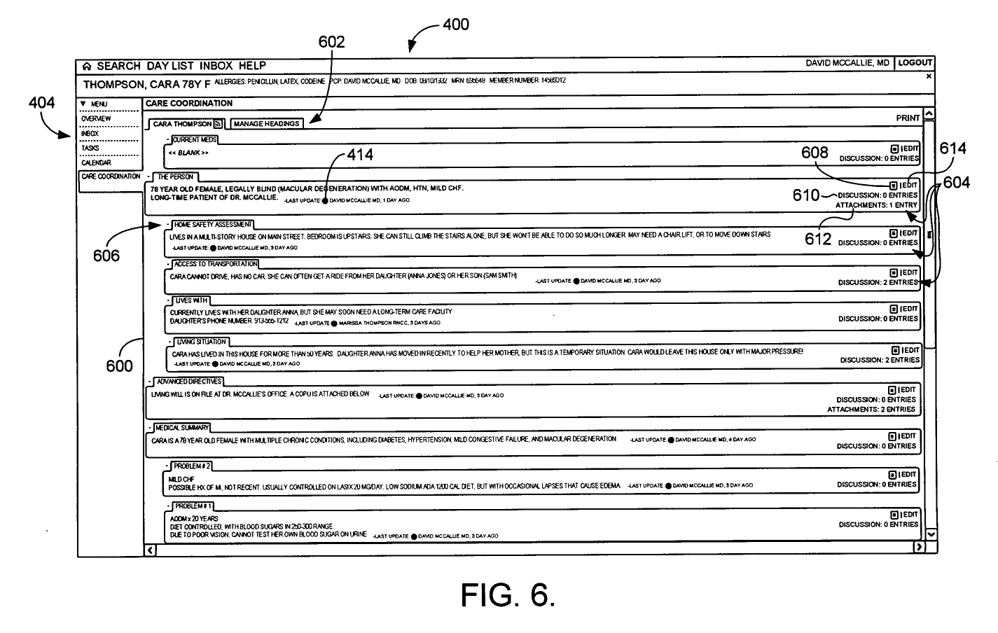

The top-level menu 404 also provides a CARE COORDINATION option, the selection of which causes the generation of window 600 on screen display 400, as illustrated in FIG. 6. Care coordination window 600 provides tabs 602 that enable the user to elect to display various categories of information that have been inputted by a pool of clinicians utilizing the system 20 about the particular patient, or to present display options for the categories of information. Accordingly, selection of the tab 602 associated with the patient's name triggers the display of categorized information sets 604 in window 600, each associated with a topical top-level heading, and optionally, a subheading (both referred to herein generically as “headings”). As one example, a top-level heading may include “The Person”, with subheadings under this top-level heading including “Home Safety Assessment”, “Access to Transportation”, who the person “Lives With” and their overall “Living Situation”. In the exemplary arrangement depicted in FIG. 6, only the edited version of an original information entry (i.e., a “primary” entry) in a particular information set 604 is displayed. However, additional information entries in the information sets 604 by the same clinician or other clinicians may also be displayed, as explained in further detail below. Expand/contract icons 606 associated with the headings are also provided in order to selectively display any subheadings beneath a specific heading.

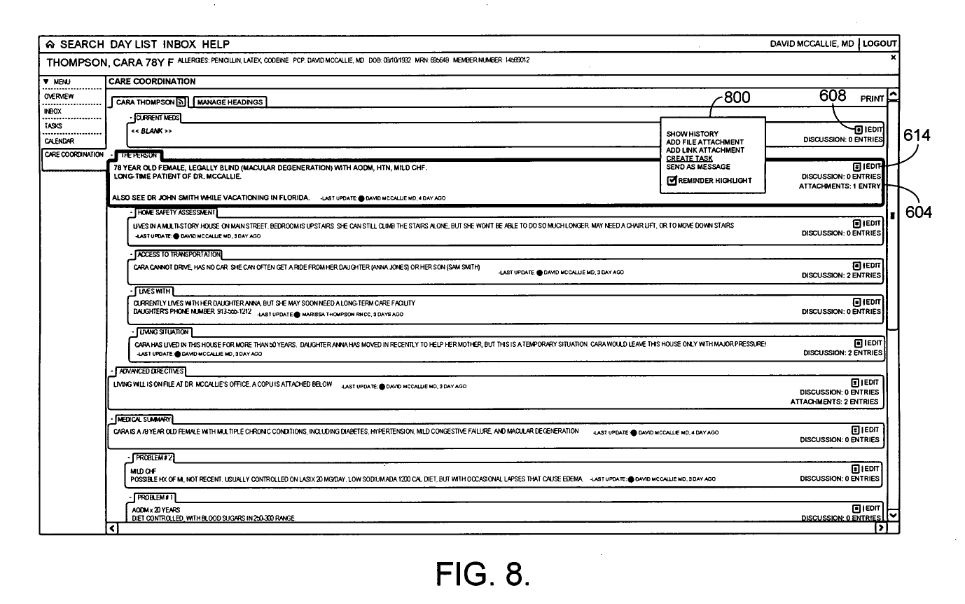

Each information set 604 identifies the clinician that provided the particular entry displayed, when the entry was made, and also displays the presence icon 414 for the clinician. An option icon 608 is also provided for controlling the format of information display within the set 604 for the particular clinician, as well as for initiating other activities, as explained in further detail below with respect to FIG. 8. A selectable “Discussion” option 610 is presented for viewing discussion entries under a particular primary information entry and a selectable “Attachments” option 612 is presented to enable attachment of certain files to the entry. The number of discussion point entries entered into the information set 604 and the number of file attachments to the information set 604 are also presented. A selectable “Edit” option 614 is also presented for adding or editing a discussion point entry to the information set 604. The patient-specific content provided in the information sets 604 is organized and managed by the content management module 202, with the display module 204 controlling the actual presentation of the content within the care coordination window 600 and the editing module 206 controlling how content is added or edited within the information sets 604.

Clinicians may also want to stay informed of changes that are made to the patient-centric content without having to navigate through the information sets 604 displayed in the care coordination window 600. For instance, a clinician may want to receive in their electronic inbox a message notifying of changes to information sets 604 associated with a particular topical heading. This allows a clinician to be notified of changes “since the last time” the clinician accessed patient-centric content through the component modules 200.

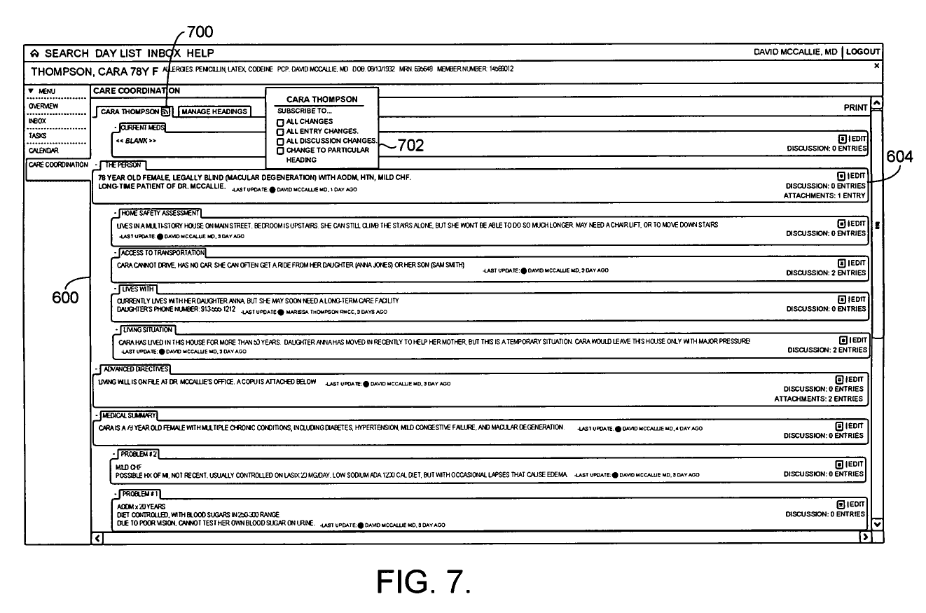

With reference to FIG. 7, a subscription icon 700 is provided adjacent to the patient's name on tab 602 for initiating a subscription request for information changes inputted in the window 600 in association with the CARE COORDINATION option being selected. Upon selection of the subscription icon 700 by the user, a subscription option sub-window 702 is generated. Sub-window 702 provides certain selectable options for designating the types of changes to information sets 604 that would trigger the automatic delivery of updates to the clinician. For instance, the clinician can subscribe to “All Changes” to patient-centric content and headings that are displayed in the care coordination window 600, including any changes to each of the information sets 604. The clinician can also subscribe to “All Entry Changes” within the information sets 604 while disregarding heading changes, “All Discussion Changes” within the information sets 604 while disregarding other entry changes, such as new file attachments, and “Changes To Particular Heading”, enabling the clinician to select a particular heading from which updates are to be generated based on changes to information sets 604 beneath or associated with the heading.

Upon the selection of an option from the sub-window 702, entry changes associated with the parameters specified by the clinician are registered, and formatted updates are generated by the subscription module 208 for the registered entry changes and delivered to the associated clinician's electronic message inbox. Alternatively, the formatted updates may be sent electronically directly to a communication device associated with the clinician as a text message. The subscription module 208 may utilize an RSS or ATOM protocol, or the like, for delivery of subscription updates that are, for instance, XML formatted. Specifically, the electronic messages embodying the subscription updates may be formatted in various ways. For instance, the messages may include the actual text of entries into the information sets 604 or an electronic link that, when selected, causes the content management module 202 to extract the entry changes from the database 24.

Selection of the option icon 608 within a particular information set 604 causes another sub-window 800 to be generated, as illustrated in FIG. 8. Sub-window 800 contains various selectable options. For instance, sub-window 800 includes a “Show History” option for providing within the information set 604 all of the versions of the primary information entry that have been entered by the authoring clinician. Sub-window 800 also includes other options for associating a file or a hyperlink with the respective information set 604, creating a new care task from the content of the information set 604 (e.g., from the primary information entry or the most recent discussion entry), and incorporating the content of the information set 604 into an electronic message to be transmitted via email or other messaging application to another clinician. Furthermore, a “Reminder Highlight” checkbox option present in sub-window 800 may be selected or deselected to correspondingly enable or disable highlighting of the background space within the respective information set 604. This background highlighting serves as a visual reminder to the clinician to reconsider the content within the respective information set 604 after the clinician has examined other information within the care coordination window 600, such as information associated with other topical headings.

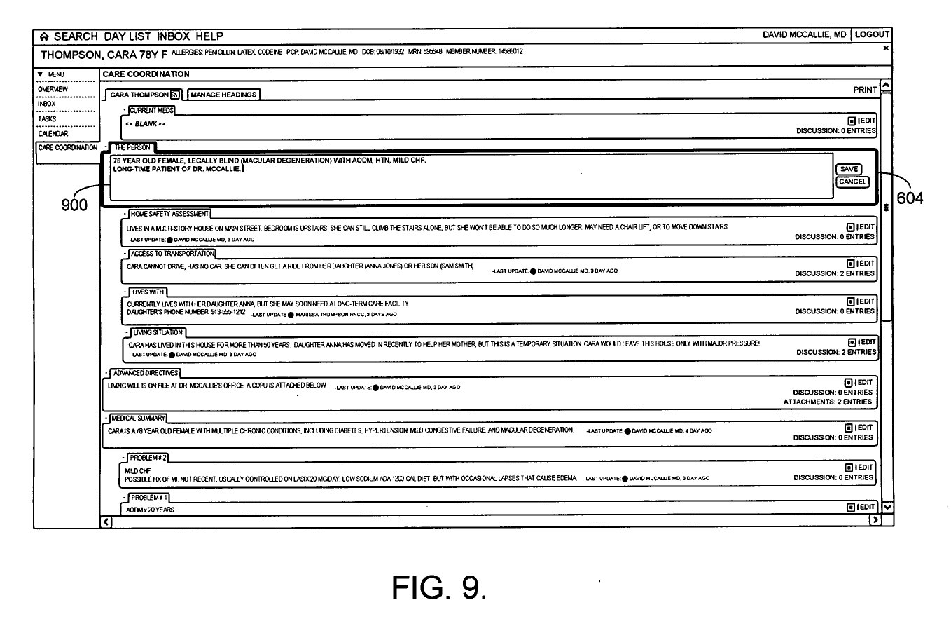

Returning to FIG. 6, when the clinician currently utilizing the system 20 to view the patient-related content within the care coordination window 600 and the clinician that created the primary information entry within a particular information set 604 are one and the same, the “Edit” option within the respective information set 604 serves as a functioning link for authoring a new version of the primary entry. For instance, when David McCallie, MD authored a primary information entry under the “The Person” heading, and Dr. McCallie is currently accessing the care coordination window 600, selection of the “Edit” option 614 causes the display module 204 to present the format of the respective information set 604 depicted in FIG. 9 for Dr. McCallie. In particular, a textbox 900 is opened within the respective information set 604 and populated by the latest version of the primary information entry, as edited by the authoring clinician (i.e., Dr. McCallie). The clinician can edit the entry as desired, and the editing module 206 saves the edited entry as a new version of the primary information entry.

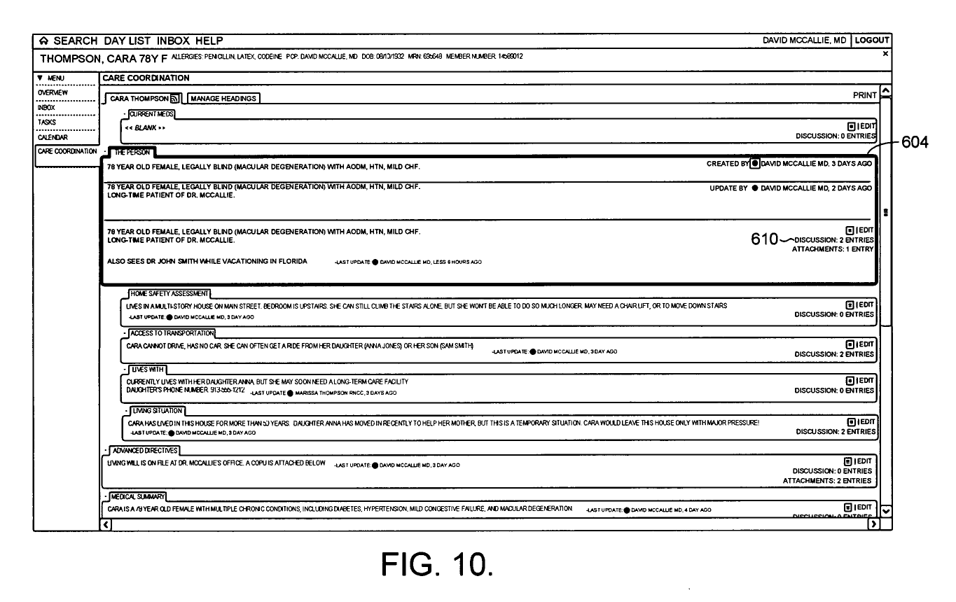

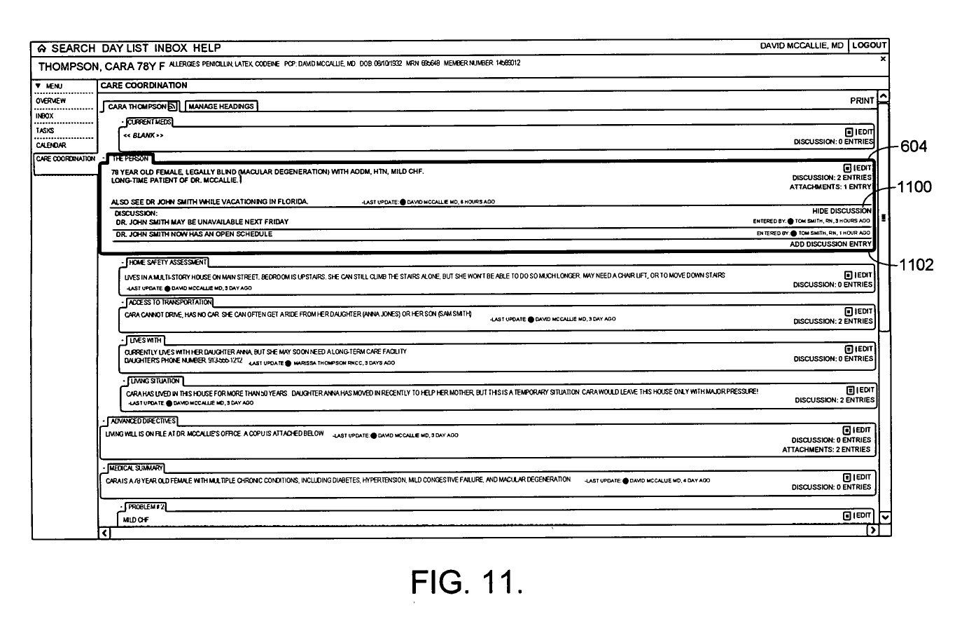

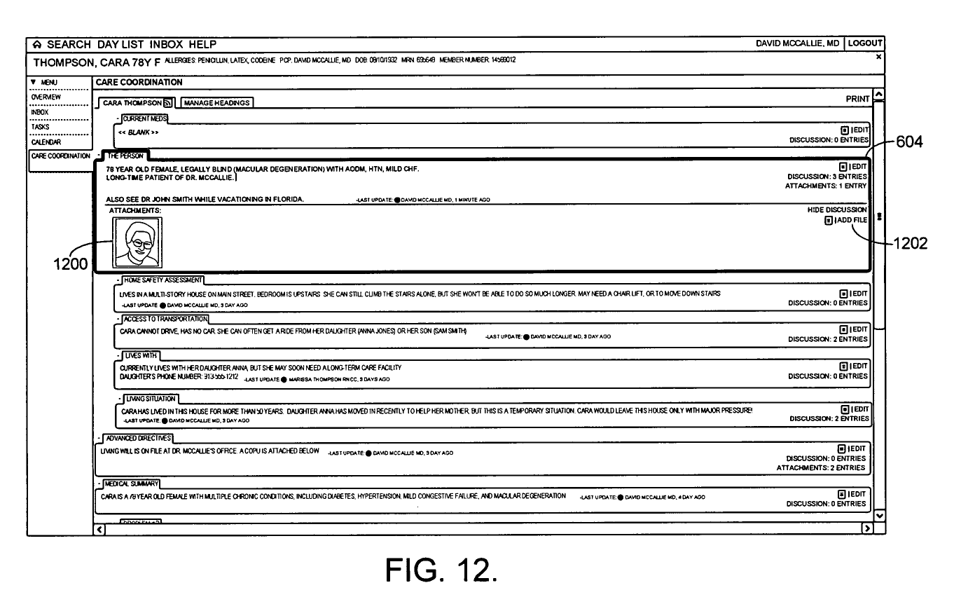

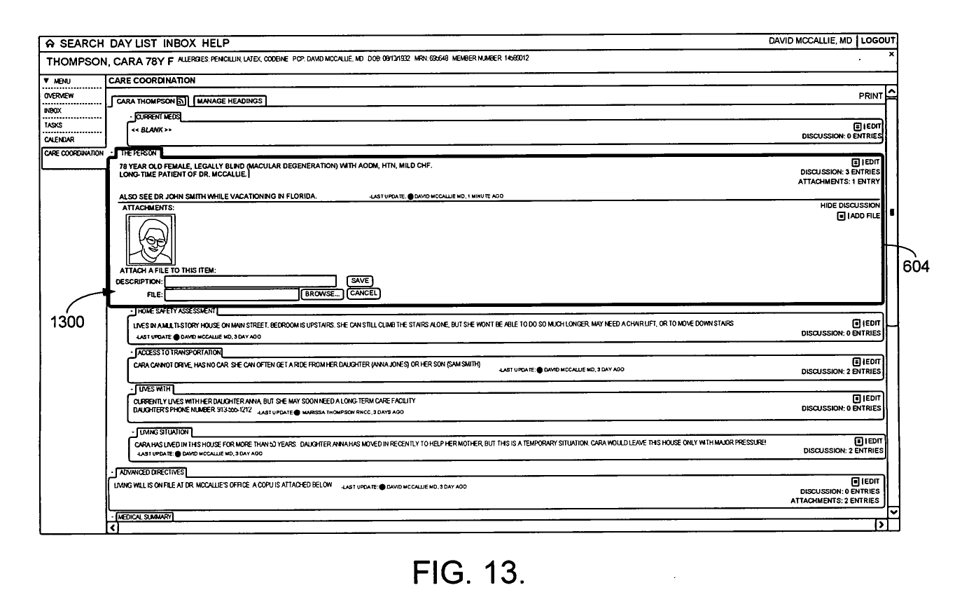

Within sub-window 800 of FIG. 8, selection of the “Show History” option causes the information set 604 to be populated with each version or update of the primary information entry created by the authoring clinician, including the relative time of creation of each version, as illustrated in FIG. 10. This allows the user to view how the current version of the primary information entry came about over time. Within FIG. 10, and as depicted in other figures displaying the information sets 604, selection of the “Discussion” option 610 causes the respective information set 604 to be populated by discussion entries that have been entered by clinicians other than the clinician that authored the primary information entry that are in response to information of the primary entry, as illustrated in FIG. 11. Selection of the “Hide Discussion” option 1100 causes the information set 604 to return to displaying only the primary information entry, while selection of the “Add Discussion Entry” 1102 allows the clinician to add another entry in the discussion category. Additionally, selection of the “Attachments” option 612 causes any graphics-based file attachments 1200 associated with the particular information set 604 to open directly within the particular information set 604, as illustrated in FIG. 12, and other file attachment formats to open in their respective applications on the computer 28 utilized by the clinician. When any file attachments have been opened within the information set 604, a selectable “Add File” option 1202 is presented, enabling the clinician to upload and associate a particular file attachment specifically with existing file attachments of the information set 604, or with the particular information set 604 generally, as depicted in FIG. 13. Specifically, textboxes 1300 enable searching of the database or other storage location to find such a file attachment, and give the attachment an appropriate identification label.

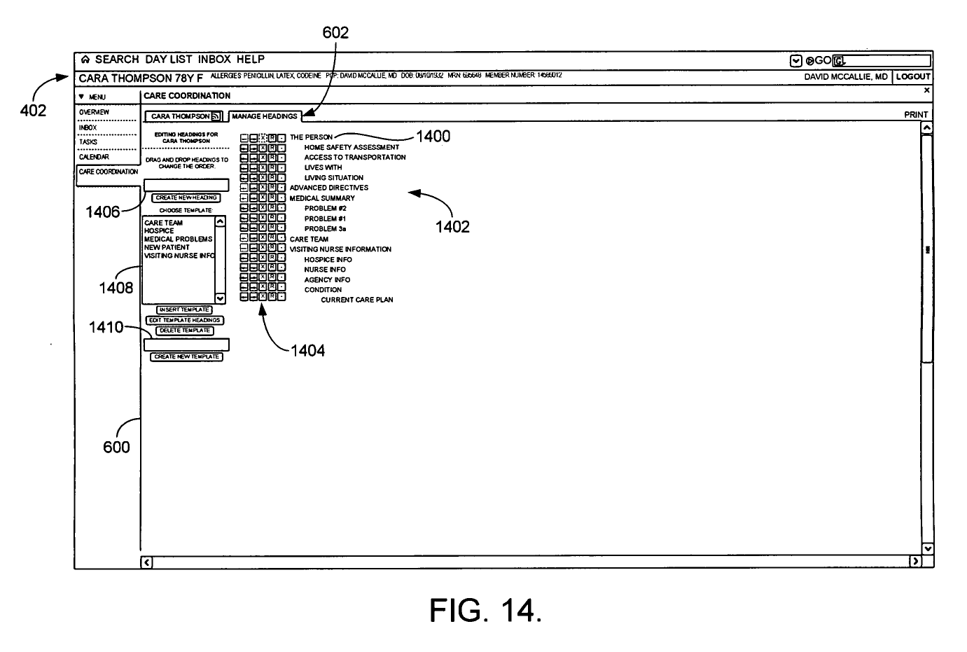

Returning to FIG. 6, selection of the MANAGE HEADINGS tab 602 causes care coordination the window 600 to present the options for displaying various topical headings for the selected patient, as illustrated in FIG. 14. This enables a clinician to establish which default headings are to be displayed, and in what particular format, when a certain patient is selected (i.e., the patient listed in the patient identification region 402). Each selectable heading 1400 is presented within a dynamic heading list 1402, with individual headings 1400 within the list 1402 being moveable (e.g., by “drag and drop”) with respect to other headings 1400. Each heading 1400 is associated with a set of presentation icons 1404, the selection and deselection of which control the hierarchy of the headings (e.g., top-level heading versus subheading), whether an information set 604 under a particular heading may have discussion entries or file attachments added thereto, and other specifics as to how information under the headings is formatted and presented. Additionally, new headings may be created through input into the headings textbox 1406, and templates may be selected from a preexisting template list 1408. Each template allows the clinician to take advantage of the headings list 1402 in an organized form on a repetitive basis, so that the clinician has their desired organized format for the headings in the care coordination window 600 when a certain care situation is encountered. For instance, when a new patient encounters the healthcare information system, a treating clinician may desire to focus on certain aspects of care delivery and/or coordination more than others. Therefore, an appropriate template is created for presenting headings most relevant to managing care delivery for a new patient (e.g., with a chronic condition such as diabetes). Alternatively, a new template can be associated with the headings list 1402 once the clinician has the headings list 1402 in a desired form, by giving the template a title in template textbox 1410. The display module 206 then associates the current form of the heading list 1402 with the entered template name.

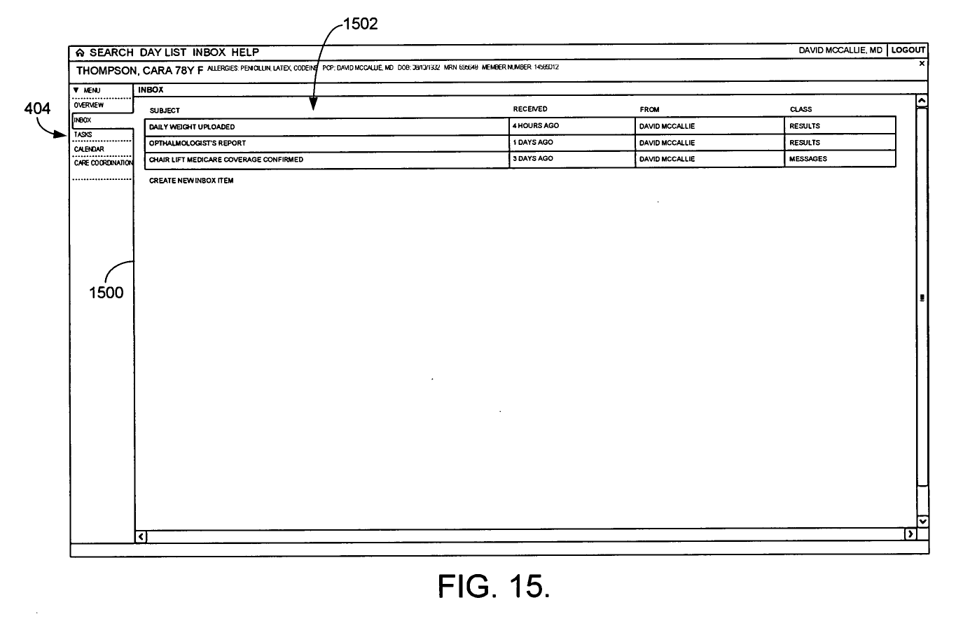

In addition to being presented with a general overview of care-related information for a specific patient, and participating in care coordination information sharing, the clinician can also view electronic mail messages and other notifications that have been associated with the clinician by selecting an INBOX option from the top-level menu 404. As illustrated in FIG. 15, when the INBOX option is selected, window 1500 is populated with a list of entries 1502 each associated with a particular item received in the clinician's inbox. Each entry item includes the text of a message or notification, as well as a classification for the item. For instance, items classified as “messages” are electronic mail messages that have been sent by other clinicians. On the other hand, items classified as “results” include notifications that are automatically generated and associated with the particular clinician when the occurrence of care related activities are registered by the system 20 for the particular patient. As one example, when information is uploaded to the electronic health record of a patient (or other storage location associated with the patient), a corresponding notification is generated and associated with the inbox of each clinician listed as handling care issues in the electronic records of the particular patient. A clinician may also create inbox items directly in window 1500 to serve as reminders to themselves when they next access their associated inbox through selection on the top-level menu 404.

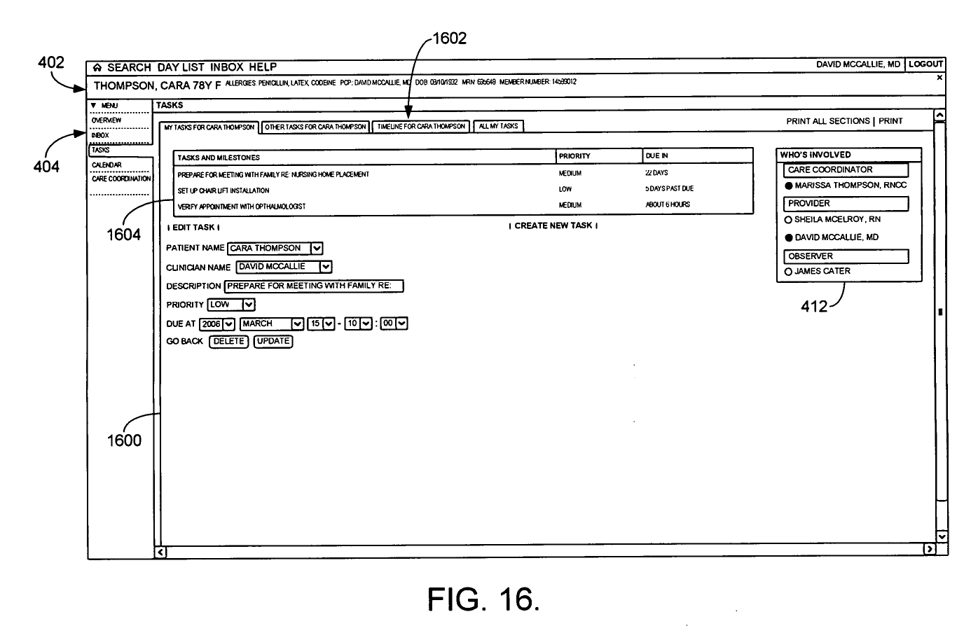

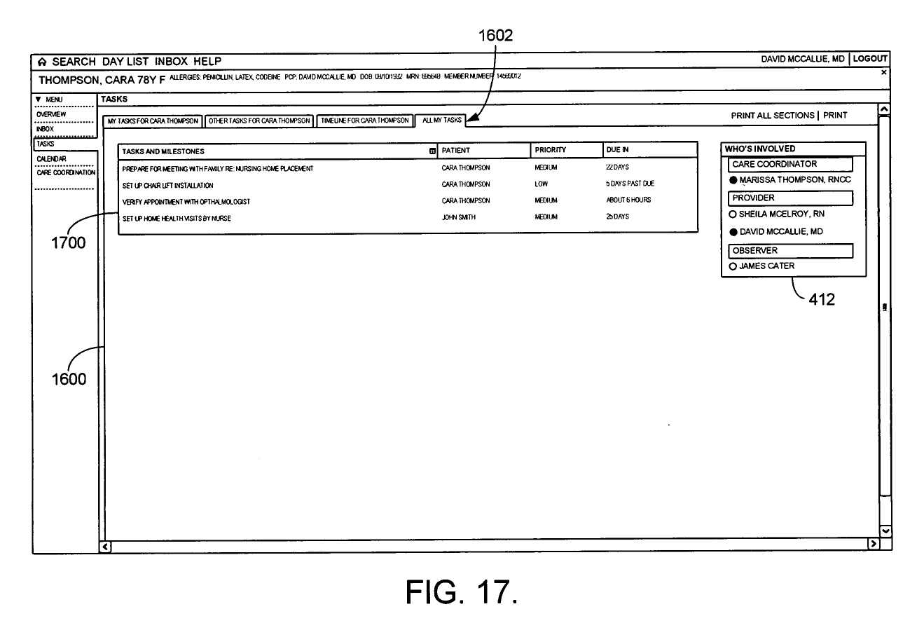

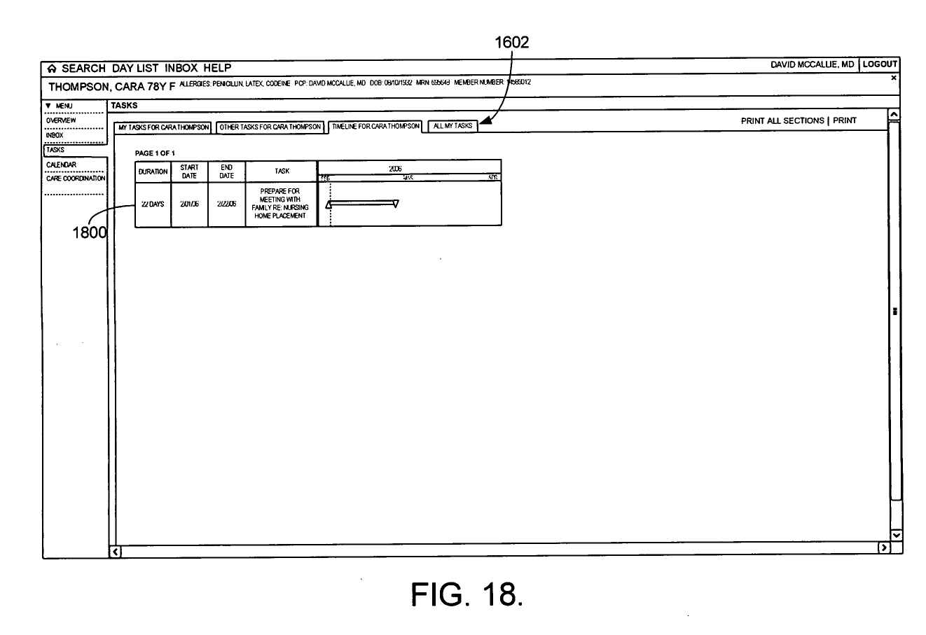

With reference to FIG. 16, selection of the TASKS option from the top-level menu 404 causes a window 1600 to be populated with information regarding tasks that have been established in directing the delivery or management of care for a particular patient or for a number of patients handled by a particular clinician. Tabs 1602 are provided within window 1600 for selectively presenting task information in a formatted table according to certain organizational schemes. For instance, a selection may be made on the tabs 1602 to cause window 1600 to be populated with tasks and milestone information associated with the particular clinician regarding care activities for a particular patient listed in the patient identification region 402, along with the assigned priority of the task and when it needs to be completed, as illustrated in FIG. 16. Alternatively, the tabs 1602 may also provide options for displaying similar task-related information for all clinicians that provide care activities for the particular patient, for task-related information associated with all patients that receive care from the particular clinician, as depicted for table 1700 in FIG. 17, and for a timeline view providing a table 1800 depicting graphically the duration of tasks that are associated with the particular patient, as depicted in FIG. 18. With respect to FIG. 16, window 1600 also presents an “Edit Task” option for changing the parameters surrounding an existing task or milestone entry, and a “Create New Task” option for generating a new task or milestone entry. As with screen display 400 illustrated in FIG. 4, windows 1600 in FIGS. 16 and 17 also each present a region 412 listing clinicians of record in handing care related issues for the particular patient, along with associated presence icons 414.

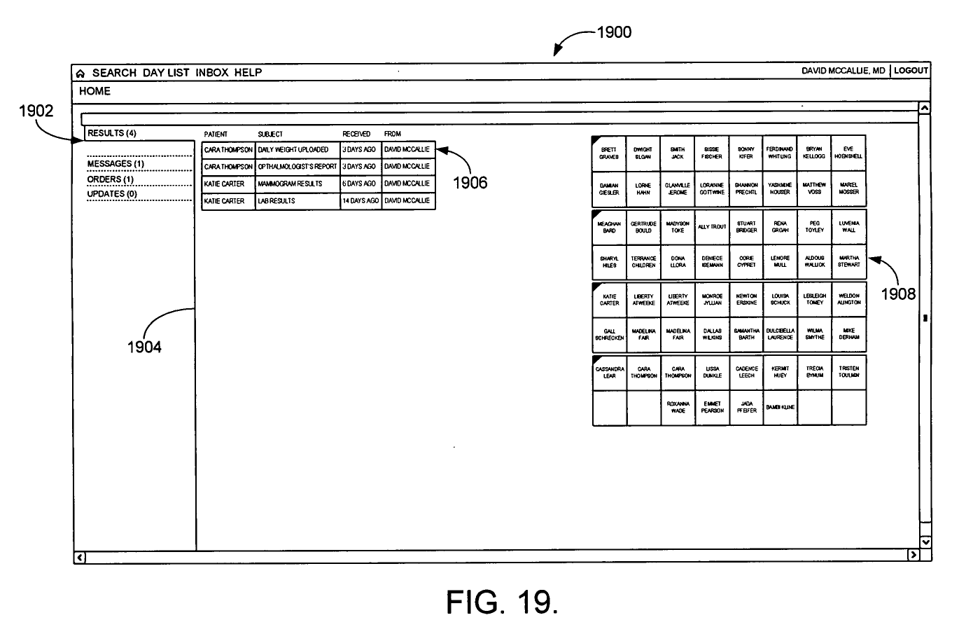

As referenced above, the prioritization of care management within a particular patient population has proven to be a difficult task for health service coordinators. One exemplary screen display 1900 for providing visual guidance in prioritizing patients for receiving care within a patient population is illustrated in FIG. 19. Screen display 1900 presents a menu 1902 of selectable options each providing, upon being selected, certain content within a window 1904. For instance, when the RESULTS option is selected, window 1904 is populated with a list of entries 1906 associated with recent information uploads for the patient population (e.g., the electronic health records of patients within a CHR) and an ordered chart 1908 of patients within the population. In the exemplary arrangement of the ordered chart 1908 shown, the patients are ordered in row form starting at the top, left corner of the chart 1908 and moving left-to-right down each row to the bottom, right corner of the chart 1908. The ordering of the patients in the chart 1908 from the top, left corner moving down to the bottom, right corner represents a ranking of the patients in terms of the need to receive healthcare services, as determined by the prioritization module 210. Accordingly, with the exemplary ordered chart 1908 entries shown, “Brett Graves” would be a higher priority patient than a patient in a lower row of the chart 1908, as well as patients farther to the right but in the same row of the chart 1908. Particular ranking values for the patients within the ordered chart 1908 may also be represented by color variations or other visual indicators applied to the chart 1908, enabling the care coordinator to quickly determine which patients are designated as more in need of care as compared to other patients of the patient population. The menu 1902 also provides options for the clinician accessing the screen display 1900 to view messages in their inbox, activity surrounding clinician orders that the clinician has placed (e.g., expiration of a current prescription), and updates within the care coordination window of patient-related information to which the clinician has subscribed.

In an embodiment, the ranking of the need to receive care among the patient population is determined from a variety of factors, including, for a given patient, one or more of the urgency of the need to receive care for the patient (i.e., the “urgency” factor), the importance of receiving care for the patient (i.e., the “importance” factor), the quantity of procedures necessary for delivering care to the patient (i.e., the “quantity” factor), and the nature of the care to be delivered to the patient (i.e., the “nature” factor). A nonexhaustive list of sources of patient-related information considered in establishing a value for each factor include: patient-specific calendars of care events, such as medical appointments and procedures, a patient's electronic health record (e.g., medical claims for the patient, diagnosed health/condition issues, prescriptions ordered), a community health record, including patient-specific information and general information for the patient population, sources of evidence-based medical or clinical knowledge (e.g., MULTUM database offered by Cerner Multum, Inc.), activity information captured in care coordination records (e.g., information inputted in the care coordination window 600, electronic messages received in a clinician's inbox, tasks generated and associated priorities assigned thereto, etc.), and a record of quantitative values assigned to certain elements (e.g., severity scores assigned to diagnosis or condition information).

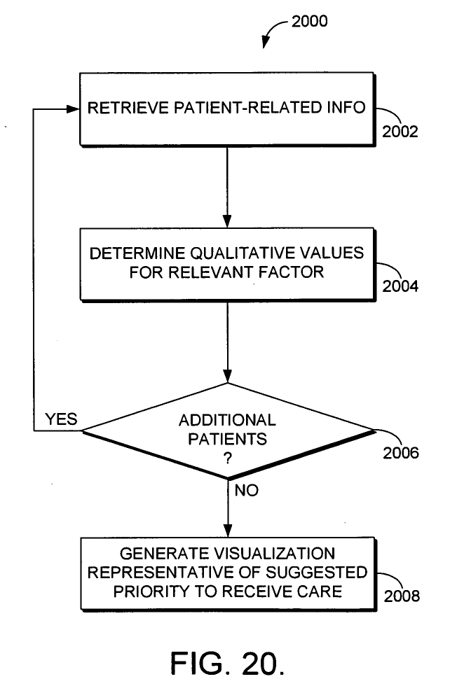

One exemplary computerized method 2000 for generating a visualization representative of a suggested priority for individual patients within a patient population to receive care is represented by the flow diagram depicted in FIG. 20. This method 2000 takes into consideration primarily the urgency and importance factors, with the quantity and nature factors being at least in part subsumed within the urgency and importance factors. At a first step 2002 of the method 2000, patient-specific data is retrieved from the sources of health information relevant in establishing a qualitative value for the urgency and importance factors. For instance, information sources containing care event scheduling data, recent activity data within a patient/community health record, and recent care coordination record activity data are considered particularly relevant for the urgency factor, while information sources containing evidence-based medical or clinical knowledge data and diagnosis/condition valuation data, as well as recent activity data within a patient/community health record and recent care coordination record activity data, are considered particularly relevant for the importance factor.

Specific examples of data that can influence the urgency factor are provided in Table 1 below.

TABLE 1

| Data Types | Examples |
|---|---|
| Care Event | Scheduled future clinical appointments |
| Scheduling Data | Completed clinical appointments |
| | Missed clinical appointments |
| | Temporal proximity of clinical appointments |
| | to the current date/time |
| PHR/CCR | Quantity and temporal proximity of prescription/ |
| Activity Data | clinical order related events to the current |
| | date/time (e.g., recently issued prescription, |
| | expired prescription, a pending prescription |
| | refill event, etc.) |
| Care Coordination | Sufficient quantity of information inputted into |
| Activity Data | the care coordination window within a |
| | preestablished block of time |

Similarly, specific examples of data that can influence the importance factor are provided in Table 2 below.

TABLE 2

| Data Types | Examples |
|---|---|
| Evidence-based | Health ailments/conditions numerically scored |
| Medical or Clinical | based on severity |
| Knowledge Data | |
| PHR/CCR | Quantity and temporal proximity of health care |
| Activity Data | procedure/activity |
| | Health care procedure/activity numerically scored |
| | based on extensive nature |
| Care Coordination | Quantity and subjective rankings of care |
| Activity Data | coordination activities (e.g., tasks, to do's, |
| | milestone created by clinicians) |
| | Temporal proximity of care coordination activities |
| | to the current date |

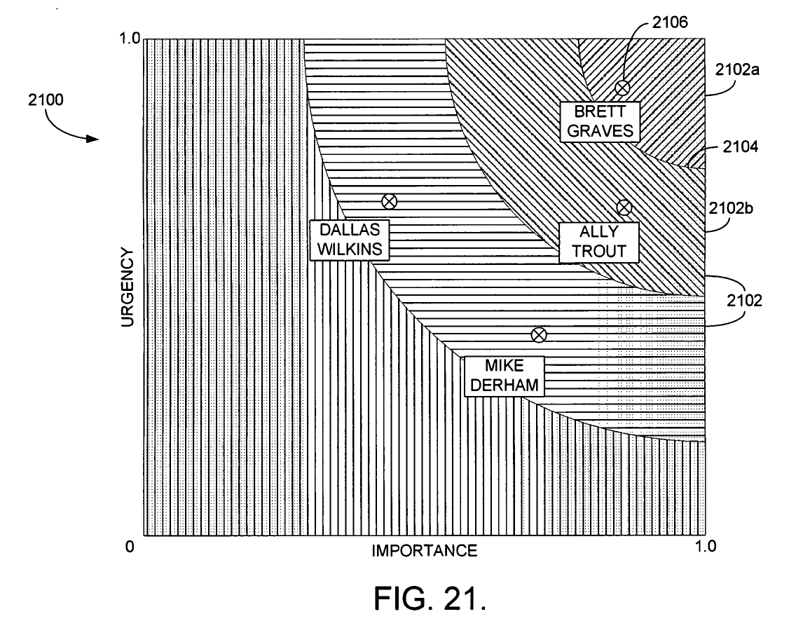

Upon retrieval of the patient-specific data, a calculation of the actual qualitative values for each the urgency and importance factors in made at step 2004. Different weightings can be applied to particular data types that combine to influence the qualitative values of the urgency and importance factors, based on, for instance, the preferences of a particular treating clinician or a health system administrator responsible for overseeing care delivery for the patient population. As an example, the urgency and importance factors may each be values on a scale from 0.0 to 1.0, with a higher number representative of a stronger urgency and importance ranking than a lower number. Thus, a patient having a [1.0, 1.0] ranking would represent the patient with the highest possible need to receive care based on urgency and importance consideration. The representation of the qualitative values of the urgency and importance factors in a visualization scheme is discussed in more detail below with respect to FIGS. 19 and 21.

A determination is then made as to whether patient-specific data should be retrieved for additional patients. If patient-specific data should be retrieved for additional patients, then the method 2000 returns to step 2002, On the other hand, if patient-specific data has been retrieved for each patient desired (e.g., for the portion of the patient population in which the priority to receive care is to be determined), then a visualization representative of the suggested priority for individual patients within a patient population to receive care is generated at step 2008, examples of which include ordered chart 1908 of FIG. 19 and a graphical plot provided on a screen display 2100 in FIG. 21.

One practical implementation of the method 2000 is set out below for an exemplary group of patients with a sample set of patient-specific data that has been retrieved. Table 3-5 each present data relevant in establishing a qualitative value for the urgency and importance factors for a particular patient.

TABLE 3
Patient A

| | |
|---|---|
| Care Event Scheduling | 1 missed clinical appointment 3 days ago |
| Data (Calendar) | 2 missed clinical appointments within the last |
| | 30 days |
| | 2 scheduled clinical appointments within the |
| | next week |
| Evidence-based | 3 ailments of low severity |
| Medical or Clinical | 2 ailments of medium severity |
| Knowledge Data | 1 ailment of high severity |
| (Condition) | |
| PHR/CCR Activity | 1 clinical visit encoded as extensive, 10 days |
| Data (Encounter) | ago |
| | 2 prescription refill events within the last |
| | 7 days |
| | 1 prescription refill event expected within the |
| | next 4 days |
| Care Coordination | 5 care coordination information set updates (no |
| Activity Data | time specified) |
| (Communication | 2 discussion entries (no time specified) |
| Event) | 2 urgent milestones added within the last week |
| | 5 tasks added within the last 30 days |

TABLE 4
Patient B

| | |
|---|---|
| Care Event Scheduling | No missed clinical appointments within the |
| Data (Calendar) | last 30 days |
| | Next home health visit scheduled within the |
| | next 45 days |
| Evidence-based | 3 ailments of low severity |
| Medical or Clinical | |
| Knowledge Data | |
| (Condition) | |
| PHR/CCR Activity | 1 clinical visit encoded as limited, 35 days |
| Data (Encounter) | ago |
| | 1 prescription refill event expected within |
| | the next 4 days |
| Care Coordination | 1 care coordination information set update |
| Activity Data | within the last 30 days |
| (Communication | 0 discussion entries |
| Event) | No milestones added within the last week |
| | No tasks added within the last 30 days |

TABLE 5
Patient C

| | |
|---|---|
| Care Event Scheduling | 1 missed clinical appointment within the last |
| Data (Calendar) | 30 days |
| | 1 scheduled clinical appointments within the |
| | next 30 days |
| Evidence-based | 2 ailments of low severity |
| Medical or Clinical | 1 ailment of high severity |
| Knowledge Data | |
| (Condition) | |
| PHR/CCR Activity | 1 clinical visit encoded as limited, 10 days |
| Data (Encounter) | ago |
| | 1 prescription refill event expected within |
| | the next 21 days |
| Care Coordination | 3 care coordination information set update |
| Activity Data | within the last 30 days |
| (Communication | 0 discussion entries |
| Event) | 1 normal milestone added within the last week |
| | 2 tasks added within the last 30 days |

The qualitative value for the importance factor is then calculated as follows:

Importance=min(1.0,[ConditionImportance+EncounterImportance+CommunicationEventlmportance]/3)

where:
ConditionImportance=sum(ConditionRating)
EncounterImportance=sum(EncounterRating*ProximityFactor)
CommunicationEventlmportance=sum(CommunicationEventRating*ProximityFactor)
and:
ProximityFactor=1.0 if event within 0 to 7 days
0.5 if event within 8 to 30 days
0.25 if event within 31 to 180 days

Scores are also established for the following events:

| | |
|---|---|
| Ailment, low severity | 0.05 |
| Ailment, med severity | 0.20 |
| Ailment, high severity | 0.50 |
| Clinical visit, extensive | 1.00 |
| Clinical visit, limited | 0.20 |
| Prescription refill | 0.20 |
| Prescription expiration | 0.20 |
| Care coordination update | 0.05 |
| Discussion entry | 0.05 |
| Milestone addition | 0.20 |
| Task addition | 0.10 |
| Missed appointment | 0.40 |
| Upcoming appointment | 0.20 |

Accordingly, the results for the importance factor are as follows:

### Person A

ConditionImportance=(3*0.05)+(2*0.2)+(1*0.5)=1.05

EncounterImportance=(1.0*0.5)=0.5

CommunicationEventlmportance=(2*0.2*1.0)+(5*0.1*0.5)=0.65

ImportanceFactor=min(1.0, [1.05+0.5+0.65]/3)=0.73333

### Person B

ConditionImportance=(3*0.05)=0.15

EncounterImportance=(0.2*1*0.25)=0.05

CommunicationEventlmportance=0

ImportanceFactor=min(1.0, [0.15+0.05+0]/3)=0.06666

### Person C

ConditionImportance=(2*0.05)+(1*0.5)=0.6

EncounterImportance=(1*0.2*0.5)=0.1

CommunicationEventlmportance=(0.2*1.0)+(0.2*2*0.5)=0.4

ImportanceFactor=min(1.0, [0.6+0.1+0.4]/3)=0.36666

The qualitative value for the urgency factor is then calculated as follows:

Urgency=min(1.0,[CalendarUrgency+EncounterUrgency+CommunicationEventUrgency]/3)

where:
CalendarUrgency=sum(CalendartRating*ProximityFactor)
EncounterUrgency=sum(EncounterRating*ProximityFactor)
CommunicationEventUrgency=sum(CommunicationEventRating*ProximityFactor)

Using the same event ratings and proximity factors as when calculating the importance factor value, the results for the urgency factor are as follows:

### Person A

CalendarUrgency=(0.4*1)+(0.4*2*0.5)+(0.2*2*1.0)=1.2

EncounterUrgency=(0.2*2*1.0)+(0.2*1*1.0)=0.6

CommunicationEventUrgency=(0.05*5)+(0.05*2)=0.35

UrgencyFactor=min(1.0, [1.2+0.6+0.35]/3)=0.7166667

### Person B

CalendarUrgency=(0.2*2*0.25)=0.1

EncounterUrgency=(0.2*1*0.5)=0.1

CommunicationEventUrgency=(0.05*1)=0.05

UrgencyFactor=min(1.0, [0.1+0.1+0.05]/3)=0.0075

### Person C

CalendarUrgency=(0.2*1*0.5)+(0.2*1*0.5)=0.2

EncounterUrgency=(0.2*1*0.5)=0.1

CommunicationEventUrgency=(0.05*3)=0.15

UrgencyFactor=min(1.0, [0.2+0.1+0.15]/3)=0.45

The three patients can then be characterized by the following [importance, urgency] points:

### Person A [0.73333, 0.71666]

### Person B [0.06666, 0.0075]

### Person C [0.4, 0.45]

As referenced above, the [1.0, 1.0] point represents a highest ranked location in terms of a patient's priority to receive care. Thus, to arrange patients within the ordered chart 1908 of FIG. 19 based on priority, the distance from the “most important, most urgent” point is then calculated according to the following distance function:

Distance=[(1.0−importance)̂2+(1.0−urgency)̂2]̂0.5)

Therefore, the results for each patient are as follows:

Person A Distance=[(1−0.73333)̂2+(1−0.71666)̂2]̂0.5=0.68202
Person B Distance=[(1−0.06666)̂2+(1−0.0075)̂2]̂0.5=1.3624
Person C Distance=[(1−0.4)̂2+(1−0.45)̂2]̂0.5=0.81394

Among this group, Person A would be the highest priority patient, followed by Person C and Person B. Person A would thus be in at least as high a row in the chart 1908 as Person C and Person B, and if in fact was in the same row, then Person A would be more to the left in the row shared with Person C and/or Person B.

Various visual indicators may be provided within the chart to denote segments of patients having a similar distance value from the [1.0, 1.0] point, and thus a similar priority ranking. For instance, different shading or color markings may be associated with portions of the chart displaying patients that are associated with specified ranges of distance values from the [1.0, 1.0] point, such that patients having a smaller distance value are shaded or marked differently from patients having a larger distance value, while still maintaining the general order of the chart 1908 where patients in higher rows and further to the left within the row are designated by the position in the chart 1908 as being higher priority. The ordered chart 1908 may also be segmented into groups of rows to further denote prioritization among the patients, as depicted in FIG. 19.

Referring again to FIG. 21, screen display 2100 provides a graphical plotting of the [importance, urgency] points 2106 for various patients against the Importance axis and the Urgency axis. Screen display 2100 is provided with a set of scoring zones 2102 each representative of a range of values for the summation of the importance factor and urgency factor calculated values. For instance, with the upper, right corner of the plot representing the [1.0, 1.0] point, or highest ranking position having a summation of 2.0, a dividing line 2104 denoting a set value on the plot that is less than the 2.0 point separates a first zone 2102a of higher priority patients from an adjacent second zone 2102b of patients with a lower priority than the first zone 2102b. Additional dividing lines 2104 and scoring zones 2102 may be provided to further segregate patients and visually denote priority to receive care based on the summation of the associated importance factor and urgency factor values, with the lowest priority patients falling into the zone 2102 that stretches to the lower, left corner of the plot representing the [0.0, 0.0] point.

One advantage of utilizing the graphical plot of FIG. 21 to designated a priority scheme is that individual scores for the priority factor and the urgency factor can also be observed. A clinician may, for example, consider a first patient with a higher urgency score more of a priority to receive care in certain situations than a second patient with a lower urgency score but with a similar overall priority designation or ranking based on the summation of both the importance factor and urgency factor. Alternatively, the opposite situation may arise, when a patient with a higher importance score, but a similar overall priority ranking to other patients, may be considered more in need of receiving care. Thus, the screen display 2100 allows for consideration of individual factors that contribute to the ranking of the need to receive care, as well as the overall ranking, in prioritizing patients to receive care.

The aforementioned system and methods have been described in relation to particular embodiments, which are intended in all respects to be illustrative rather than restrictive. Since certain changes may be made in the aforementioned system and methods without departing from the scope hereof, it is intended that all matter contained in the above description or shown in the accompanying drawing be interpreted as illustrative and not in a limiting sense.

What is claimed is:

1. A method in a computing system environment for managing the presentation of categorized patient-specific information among a plurality of users, the method comprising:
retrieving, for a particular user of the plurality of users, a patient-specific information set from a shared network site;
selectively displaying, for the particular user, the retrieved information set in a categorized format consistent with preferences designated by the particular user;
receiving, from the particular user, modifications to content of the retrieved information set displayed to form a modified patient-specific information set; and
storing, on the shared network site, the modified patient-specific information set to facilitate access by at least another user of the plurality of users to the modified patient-specific information set.

2. The method of claim 1, wherein the information set includes data representative of at least general personal information for the designated patient and care-related information for the designated patient.

3. The method of claim 1, wherein the modifications received include at least one of:
additional comments associated with at least one of a specific informational entry and a specific category;
a new informational entry;
a file attachment; and
an electronic link for navigating to additional content.

4. The method of claim 1, wherein the plurality of users are health service providers.

5. The method of claim 1, wherein selectively displaying the retrieved information set in a categorized format includes displaying the information set temporally within a plurality of categories.

6. A computer-readable medium having computer-executable instructions for performing the method of claim 1.

7. A method in a computing system environment for providing formatted updates regarding a patient based on the modification of content present on a shared network site, the method comprising:
receiving a subscription request associated with a particular care provider and a particular patient;
registering content modification on the shared network site relevant to the subscription request; and
selectively generating formatted updates for the particular care provider regarding the particular patient based on the content modification registered.

8. The method of claim 7, further comprising presenting the formatted updates within a secured access location associated with the particular care provider.

9. The method of claim 7, wherein the content present on the shared network includes patient-specific categorized information, the shared network site facilitating:
the presentation of the patient-specific categorized information; and
modification, by authorized health service providers, of the patient-specific categorized information presented.

10. The method of claim 9, wherein the subscription request relates to at least one of:
non-specific content modification on the shared network site for the particular patient;
content modification on the shared network site for the particular patient specific to one or more selected entries;
content modification on the shared network site for the particular patient specific to one or more selected categories and;
content modification on the shared network site for the particular patient specific to discussion points within at least one of the entries of the one or more selected entries.

11. The method of claim 9, wherein the content modification includes data representative of at least general personal information for the designated patient and care-related information for the designated patient.

12. A computer-readable medium having computer-executable instructions for performing the method of claim 7.

13. A computing system for managing the presentation of categorized patient-specific information among a plurality of authorized users, the computing system comprising:
a content management module for managing the organization of content on a shared network site as patient-specific categorized information;
a display module for presenting to a particular user of the plurality of authorized users the patient-specific categorized information in a format consistent with preferences designated by the particular user; and
an editing module for selectively enabling modification by the plurality of authorized users of the patient-specific categorized information.

14. The system of claim 13, further comprising a subscription module for handling a subscription request associated with a particular patient and a particular user of the plurality of authorized users and selectively generating formatted updates for the particular user regarding the particular patient based on modifications to the patient-specific categorized information.

15. The system of claim 13, wherein the patient-specific categorized information is presented by the display module in a plurality of categories, each category containing information arranged temporally.

16. The system of claim 13, wherein the patient-specific categorized information is presented by the display module in a plurality of categories to enable a particular user of the plurality of authorized users to chose between at least two of:
a first presentation mode in which only a most recent modification to the information in at least some of the plurality of categories is displayed;
a second presentation mode in which only an original informational entry within at least some of the plurality of categories is displayed;
a third presentation mode in which only selected categories of the plurality of categories are displayed; and
a fourth presentation mode where a list of modifications to the information in at least some of the plurality of categories is displayed.

17. The system of claim 13, wherein the modifications of the patient-specific categorized information enabled by the editing module include at least one of:
additional comments associated with at least one of a specific informational entry and a specific category;
a new informational entry;
a file attachment; and
an electronic link for navigating to additional content.

18. A user interface embodied on at least one computer-readable medium, the user interface for managing the presentation of patient-specific information accessible by a plurality of users, the user interface comprising at least one display region configured for presenting the patient-specific information in categorized form based on preferences designated by a particular user of the plurality of users, the patient-specific information presented including content modifications previously instituted by at least one user of the plurality of users.

19. The user interface of claim 18, wherein the patient-specific information includes data representative of at least general personal information for a designated patient and care-related information for the designated patient.

20. A method in a computing system environment for determining priority for receiving care among a plurality of patients, the method comprising:
retrieving one or more sets of patient-specific data for the plurality of patients related to care delivery;
ranking the need to receive care for each of the plurality of patients based on the one or more sets of patient-specific data retrieved; and
displaying the results of the ranking according to a visualization scheme on a user interface where patients having a similar ranking are presented proximal to one another and patients having a dissimilar ranking are presented distal to one another.

21. The method of claim 20, wherein ranking of the need to receive care is based on a patient-specific measure of at least one of:
urgency of delivering care;
importance of delivering care;
quantity of procedures needed for care delivery; and
nature of care to be delivered.

22. The method of claim 20, wherein the patient-specific data is retrieved from at least one of:
a personal health record for each patient of the plurality of patients;
a community health record for the plurality of patients; and
medical claims;

23. The method of claim 20, wherein the visualization scheme for displaying the ranking results includes an ordered chart presented in at least one display region of the user interface, the ordered chart including a listing of the plurality of patients in ranked order.

24. The method of claim 23, wherein the ordered chart has a set of regions each denoting a unique range of ranking values and provided with a distinctive visual indicator to distinguish one region from another region.

25. The method of claim 23, wherein the visualization scheme for displaying the ranking results includes a graphical plot of ranking values for the plurality of patients.

26. The method of claim 25, wherein the graphical plot has a set of regions each denoting a unique range of ranking values and provided with a distinctive visual indicator to distinguish one region from another region.

27. A computer-readable medium having computer-executable instructions for performing the method of claim 20.

28. A user interface embodied on at least one computer-readable medium, the user interface providing a visualization scheme for designating a suggested priority for receiving care among a plurality of patients, the user interface comprising at least one display region configured for presenting an ordered chart including a listing of the plurality of patients in ranked order, the ordered chart having a set of regions, each region denoting a unique range of ranking values for the plurality of patients and being provided with a distinctive visual indicator to distinguish one region from another region.

29. A user interface embodied on at least one computer-readable medium, the user interface providing a visualization scheme for designating a suggested priority for receiving care among a plurality of patients, the user interface comprising at least one display region configured for presenting a graphical plot of ranking values for the plurality of patients, the graphical plot having a set of regions, each region denoting a unique range of ranking values for the plurality of patients and being provided with a distinctive visual indicator to distinguish one region from another region.
